(19) United States
(12) Patent Application Publication
(10) Pub. No.: US 2020/0117695 A1
(43) Pub. Date: Apr. 16, 2020

(54) CREATING COMMUNITY AROUND PETS

(71) Applicant: Rashelle Lynee Black, Escondido, CA (US)

(72) Inventor: Rashelle Lynee Black, Escondido, CA (US)

(21) Appl. No.: 16/598,798

(22) Filed: Oct. 10, 2019

Related U.S. Application Data
(60) Provisional application No. 62/743,761, filed on Oct. 10, 2018.

(51) Int. Cl. G06F 16/9536; G06F 16/9535; G06F 16/9538; G06Q 50/00

(52) U.S. Cl. CPC G06F 16/9536; G06Q 50/01; G06F 16/9538; G06F 16/9535

(57) ABSTRACT

Systems and methods for bringing together pet owners and pet service providers is disclosed. One aspect is a method that includes receiving a request to access a pet service. The method further includes retrieving at least one pet service providers providing the pet service. The at least one pet service provider is associated with a composite score generated based on at least one of a verification check, a background check, and a rating. The method further includes selecting at least one of the at least one pet service providers based on the composite score.

### CROSS-REFERENCE TO RELATED APPLICATIONS

The present application claims priority to U.S. Patent Application No. 62/743,761, filed Oct. 10, 2018, entitled CREATING COMMUNITY AROUND PETS, the disclosure of which is incorporate herein by reference in its entirety

### TECHNICAL FIELD

This disclosure relates generally to a technological system (e.g., cloud computing system) that creates a trusted and verified community around pets, bringing together pet owners, pet hosts, pet professionals and pet-related businesses.

### BACKGROUND

Numerous people throughout the United States and the world are pet owners. However, many of them are often not able to depart from their pets even for short periods of time, due to high expenses of leaving pets in overnight places such as pet hotels, and lack of inexpensive places where they can leave their pets for such time. This discourages many pet owners from traveling, taking on new opportunities that require time away from pets, and take a break from routine. Furthermore, pet owners find it hard to find pet professionals or pet-servicing businesses that they can trust, such as veterinarians, urgent care providers, wellness services, pet trainers, pet sitters, pet walkers, pet groomers, pet supply providers such as pet food retailers, and/or the like. Thus, there exists a business need of creating a trusted and verified community of pet owners, pet hosts, pet professionals and pet-related businesses. There further exists a critical need to create such community in a technologically efficient manner.

### SUMMARY

Methods, systems, and articles of manufacture, including computer program products, are provided for creating a trusted and verified community around pets, bringing together pet owners, pet hosts, pet professionals and pet-related businesses. The pet hosts, pet professionals, and pet-related businesses are pet service providers. One aspect is a system including at least one processor and memory storing instructions which, when executed by the at least one data processor, result in operations. The operations include receiving a request to access a pet service from a first computing device. The operations further include retrieving, from a database, at least one pet service providers providing the pet service. The at least one pet service provider is associated with a composite score. The composite score is generated based on at least one of a verification check, a background check, and a rating. The operations further include selecting at least one of the at least one pet service providers based on the composite score of the at least one of the at least one pet service providers. The operations further include, in response to the request, routing the at least one pet service providers selected based on the composite score to the first computing device.

In various implementations, the operations may further include receiving a user selection of one of the at least one pet service providers from the first computing device. The operations may further include, in response to receiving the user selection, routing an identifier of the first computing device to a second computing device, the first computing device associated with a pet owner, the second computing device associated with a pet service provider.

In various implementations, the pet service provider includes a pet host. In various implementations, the pet service provider includes a pet professional, such as a veterinarian. In various implementations, the pet service includes a pet-related business.

In one aspect, a computing server that can include: at least one of a first software development kit and a first web module to communicate with a first computing device, a second computing device of a pet host, and a first computing device of a pet professional; an application programming interface communicatively coupled with the at least one of the first software development kit and the first web module; and a first controller communicatively coupled to the application programming interface, the first controller comprising a first configured to selectively display different aspects of a software application on the first computing device, the second computing device, and the third computing device. Related systems, apparatuses, methods, computer program products, and articles are also within the scope of this implementation.

In some variations, one or more of the following may be implemented either individually or in any feasible combination. The first computing device can be operated by a pet owner. The second computing device can be operated by a pet host. The third computing device can be operated by a pet professional. The computing server can further include a database communicatively coupled to the first processor.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description, the drawings, and the claims.

### BRIEF DESCRIPTION OF THE DRAWINGS

FIG. 1 illustrates a computing landscape executing a software application hosted by a computing server, according to some implementations of the current subject matter;

FIG. 2 illustrates a computing landscape executing a software application hosted by a computing server, where the computing server is a cloud computing server, according to some implementations of the current subject matter;

FIG. 3 illustrates a page, executed by the software application, for a pet owner to register a pet, according to some implementations of the current subject matter;

FIG. 4 illustrates a page, executed by the software application, for an individual to register as a pet host who can provide boarding and care for animals in their home through a hosting service, according to some implementations of the current subject matter;

FIG. 5 illustrates a page, executed by the software application, for a pet friendly business (e.g., a business that allows pets within the environment) to register the pet friendly business, according to some implementations of the current subject matter;

FIG. 6 illustrates another alternate page (i.e., alternate to the page of FIG. 5), executed by the software application, for a pet professional/business to register the pet professional/business, according to some implementations of the current subject matter;

FIG. 7 illustrates a page, executed by the software application, for an individual to search for a pet to share ownership, based on geographic area, pet type, and/or breed, according to some implementations of the current subject matter;

FIG. 8 illustrates an alternate page (i.e., alternate to the page of FIG. 7), executed by the software application, for a pet owner to search for pet professionals/businesses based on geographic area, pet type, pet breed, and/or services offered, according to some implementations of the current subject matter;

FIG. 9 illustrates a page, executed by the software application, for a pet owner to search for a pet friendly business (a business that allow pets within the environment) based on geographic area, pet type, and type of the pet professional/business, according to some implementations of the current subject matter;

FIG. 10 illustrates a page, executed by the software application, showing results of a search (e.g., search of FIG. 9) for a pet friendly businesses based on geographic area, according to some implementations of the current subject matter;

FIG. 11 illustrates a page, executed by the software application, showing results of a search (e.g., search of FIG. 4) for pet hosts based on geographic area, according to some implementations of the current subject matter;

FIG. 12 illustrates yet another page, executed by the software application, showing results of a search for pet professionals/businesses based on geographic area, according to some implementations of the current subject matter;

FIG. 13 illustrates a page executed by the software application for a pet owner to search for an available pet host during specific dates on a calendar, when his/her pet is in need of board and care in a specified geographical area with a pet host, according to some implementations of the current subject matter;

FIG. 14 illustrates a page, executed by the software application, showing results of a search (e.g., search of FIG. 7) by an individual for pets that are available for sharing in a specified geographic area, according to some implementations of the current subject matter;

FIG. 15 illustrates a page executed by the software application for an organizer of an event related to pets to create pet events on a calendar that can be accessed by pet owners, pet hosts, and pet professionals/businesses, according to some implementations of the current subject matter;

FIG. 16 illustrates a page, executed by the software application, where an individual can search for events related to pets, based on a calendar and geographical area, according to some implementations of the current subject matter;

FIG. 17 illustrates a page, executed by the software application, showing results of a search (e.g., search of FIG. 16) of events in a specified geographic area, according to some implementations of the current subject matter;

FIG. 18 illustrates a page, executed by the software application, where an individual can post a lost or found which includes timed information and geographical information for lost and found pets, according to some implementations of the current subject matter;

FIG. 19 illustrates a page, executed by the software application, showing search (e.g., search of FIG. 18) results with categories of most recently (e.g., within a preset amount of past time) lost and found pets, according to some implementations of the current subject matter;

FIG. 20 illustrates a page, executed by the software application, having a pet forum, where an individual can post or search subject matter, according to some implementations of the current subject matter;

FIG. 21 illustrates a page, executed by the software application, showing results of a search (e.g., search of FIG. 20) in the pet forum, according to some implementations of the current subject matter;

FIG. 22 illustrates a page, executed by the software application, where a pet owner can post a photo or video of their pet to win fame, competition, or prize, according to some implementations of the current subject matter; and

FIG. 23 illustrates a page, executed by the software application, that compares the entries made using the page and posts the winner of the competition for fame or a prize thereon, according to some implementations of the current subject matter.

FIG. 24 depicts a block diagram illustrating a computing system 2400 consistent with implementations of the current subject matter.

Like reference symbols in the various drawings indicate like elements.

### DETAILED DESCRIPTION

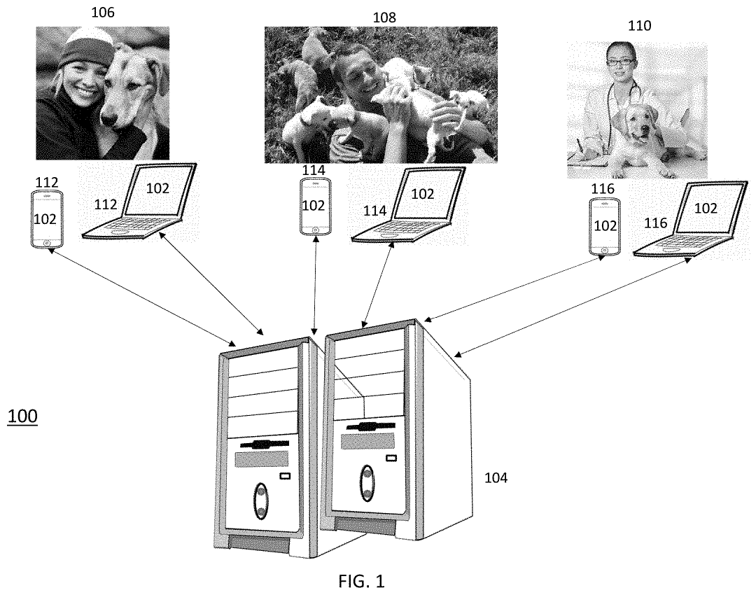

FIG. 1 illustrates a computing landscape 100 executing a software application 102 hosted by a computing server 104. The software application 102 can create a community of pet owners 106, pet hosts 108, and pet professionals or pet-related businesses 110. The pet hosts 108, pet professionals, and pet-related businesses can provide pet services. The computing server 104 can render the software application 102 on one or more computing devices 112 of a pet owner 106, one or more computing devices 114 of a pet host 108, and one or more computing devices 116 of a pet professional or pet-related business 110.

In one implementation, the computing server 104 may transmit different data to the computing devices 112, 114 and 116 based on the identity of an entity operating such device. For example, the interfaces and data displayed to each of the pet owner 106, pet host 108, and pet professional or pet-related business 110 may be different. This can be advantageous as a pet owner 106 may not want to see other pet owners 106, a pet host 108 may not want to see other pet hosts 108, and a pet professional or pet-related business 110 may not want to see other pet professionals or pet-related businesses 110. In an alternate implementation however, the interfaces and data displayed to two or more of the pet owner 106, pet host 108, and pet professional or pet-related business 110 may be the same or similar. This implementation encourages competition amongst like entities, and therefore results in best business outcomes as well as improves retention on and engagement with the website.

The software application 102 can be can be specific to the operating system—e.g., iPhone operating system (IOS), ANDROID, or any other operating system—of the computing device on which it is executed. The software application 102 may:

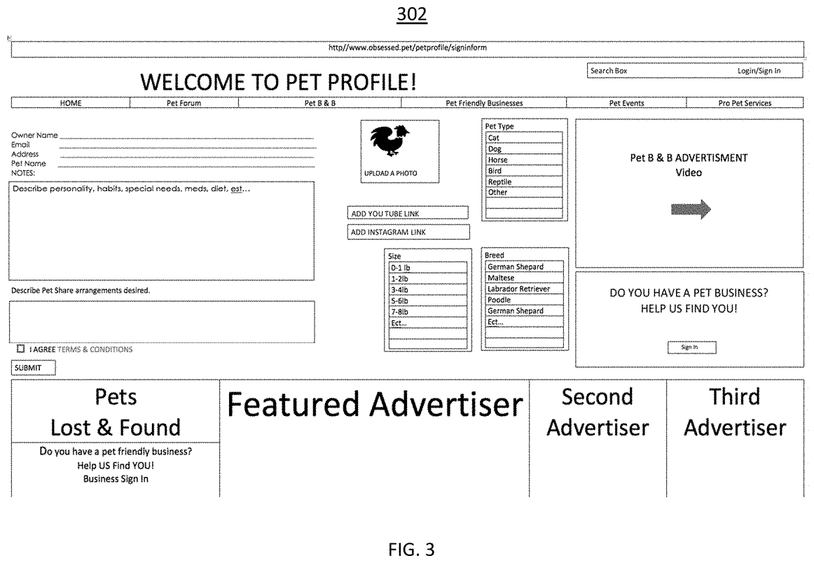

permit a pet owner to register a pet (as described by FIG. 3 below);

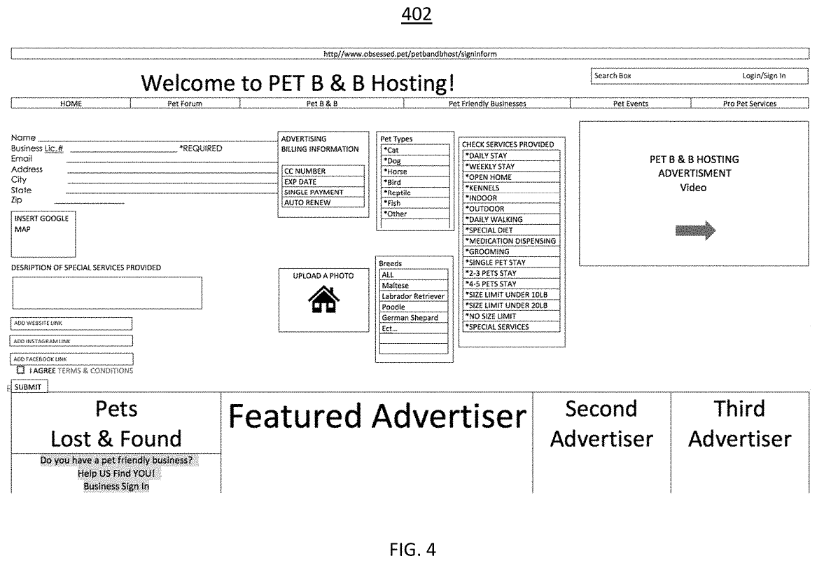

permit a pet host or pet friendly business or a pet professionals/businesses to register and or advertise for a fee, based on desired characteristics (as described by FIGS. 4-6 below);

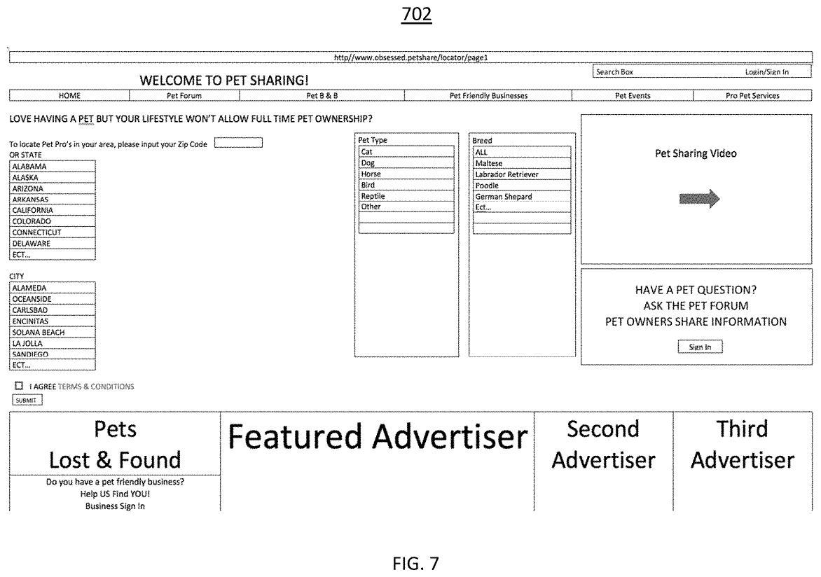

permit an individual to search for pet hosts, pet friendly businesses or pet professionals/businesses based on geographic area (as described by FIGS. 7-9 below);

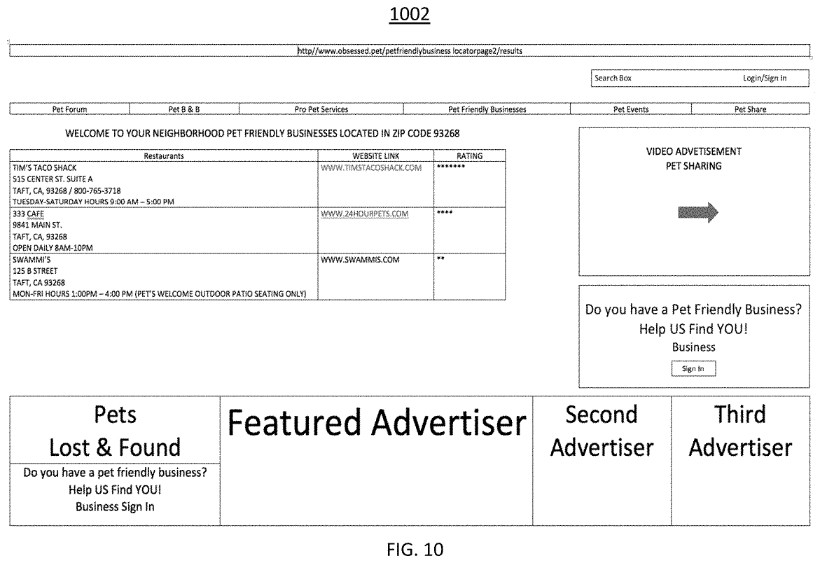

display results of a searches (e.g., searches of FIGS. 7-9) for pet hosts, pet friendly businesses or pet professional/businesses (as described by FIGS. 10-12 below);

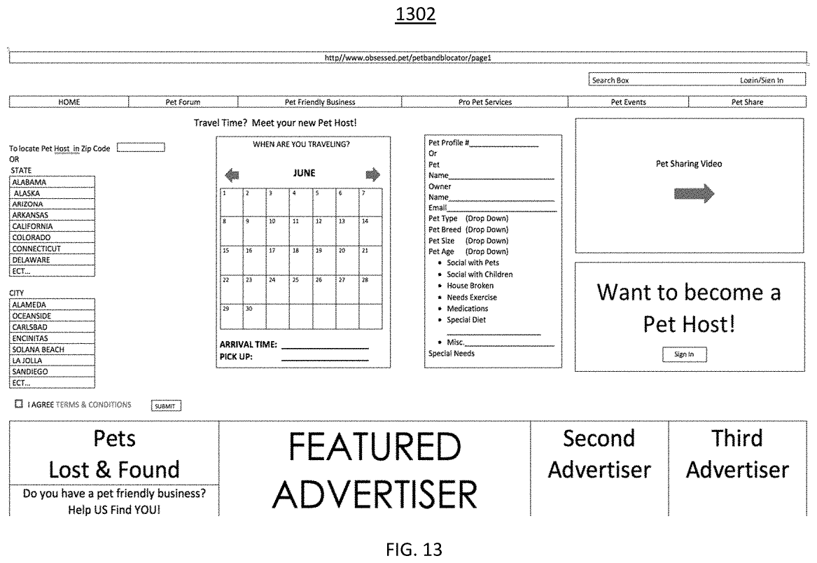

permit an individual to search for a pet host to provide board and care for their pet based on a specified time period and in a specified geographic area (as described by FIG. 13 below);

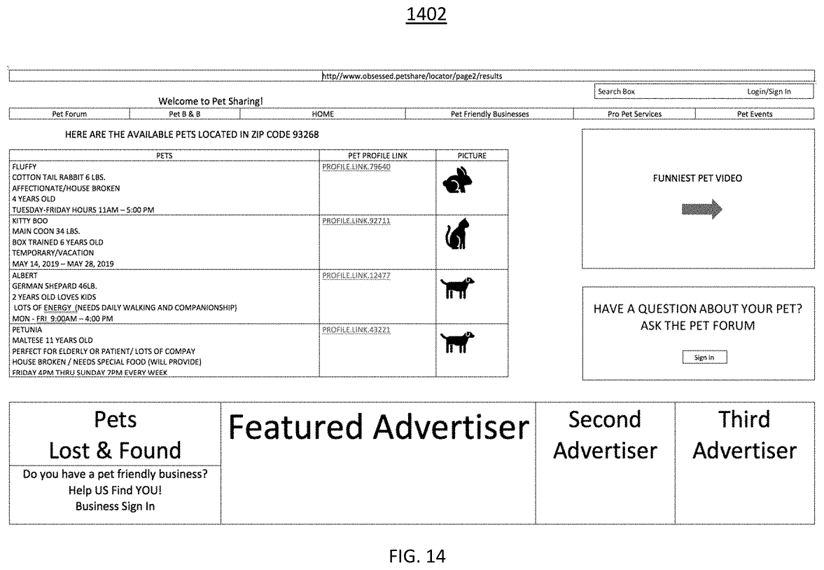

show search results for pets that are available for sharing in a geographical area, (as described by FIG. 14 below);

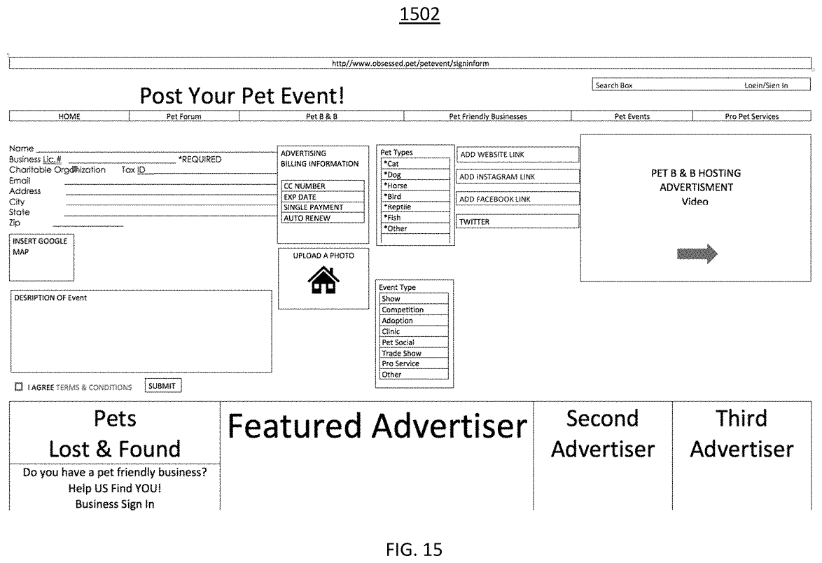

allow an organizer of an event related to pets to create pet events on a calendar that can be accessed by pet owners, pet hosts, and pet professionals/businesses (as described by FIG. 15 below);

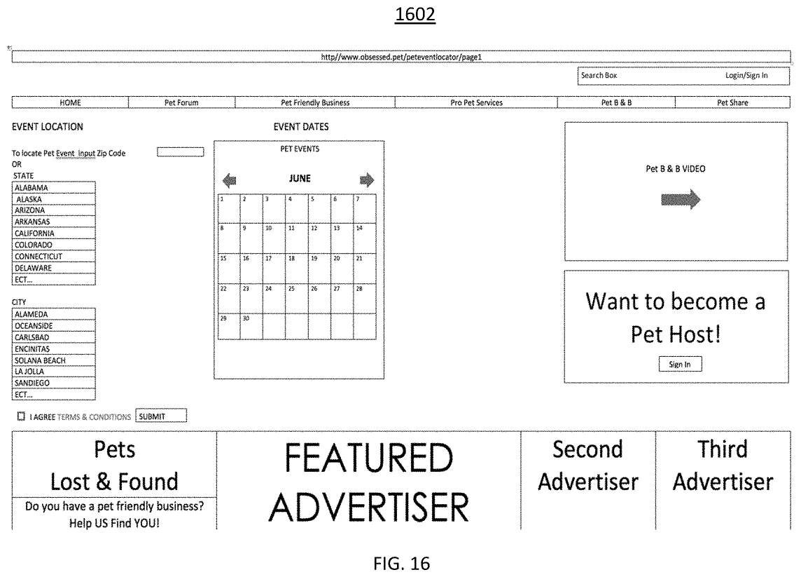

allow an individual to search for pet events based on a calendar and geographical area (as described by FIG. 16 below);

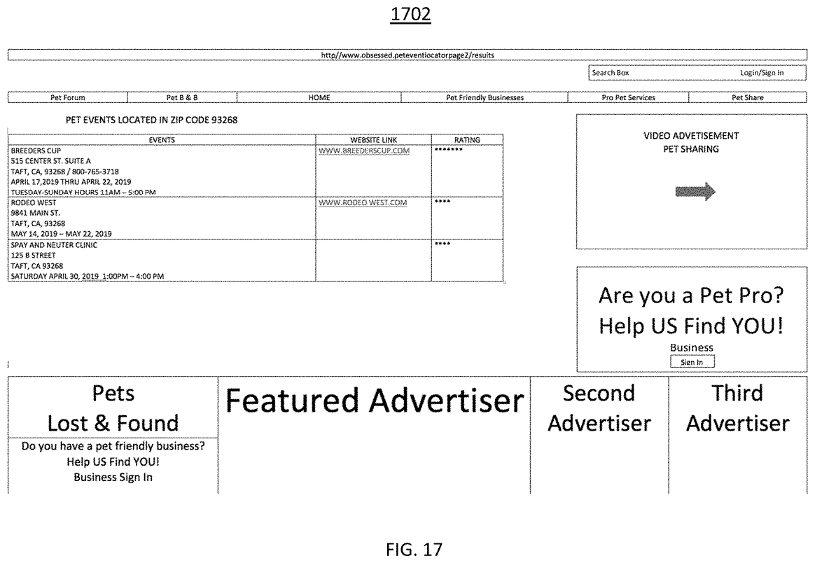

show results of a search of events in a specified geographic area (as described by FIG. 17 below);

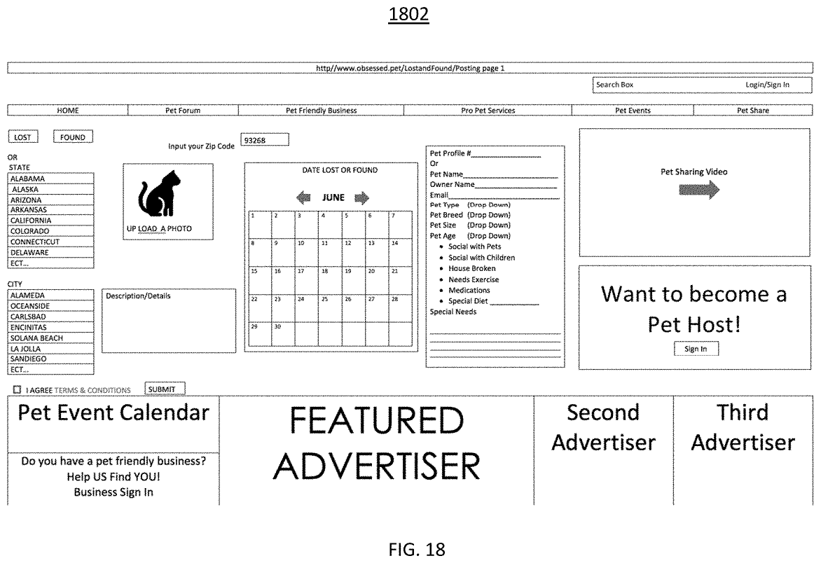

allow an individual to post or search a lost or found pet based on a calendar and geographical area (as described by FIG. 18 below);

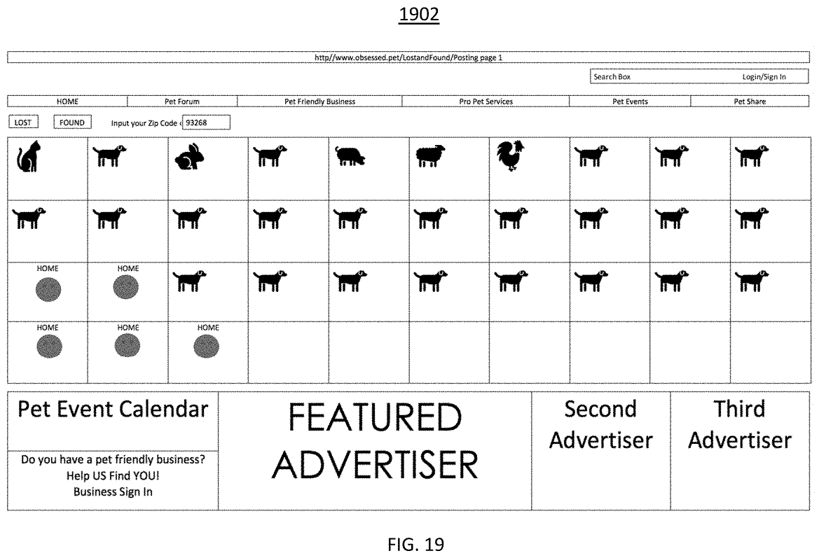

show search results in categories of most recent lost and found pets (as described by FIG. 19 below);

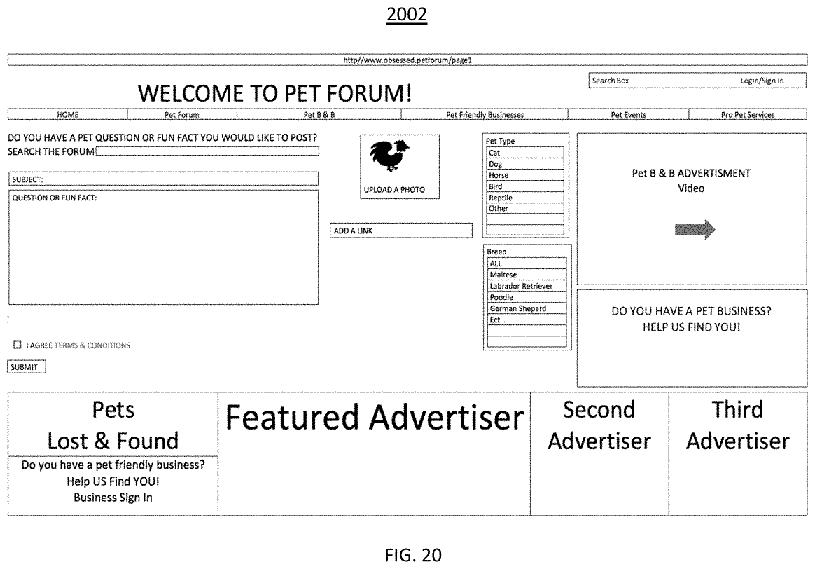

host a searchable pet forum where an individual is allowed to post information and questions (as described by FIG. 20 below);

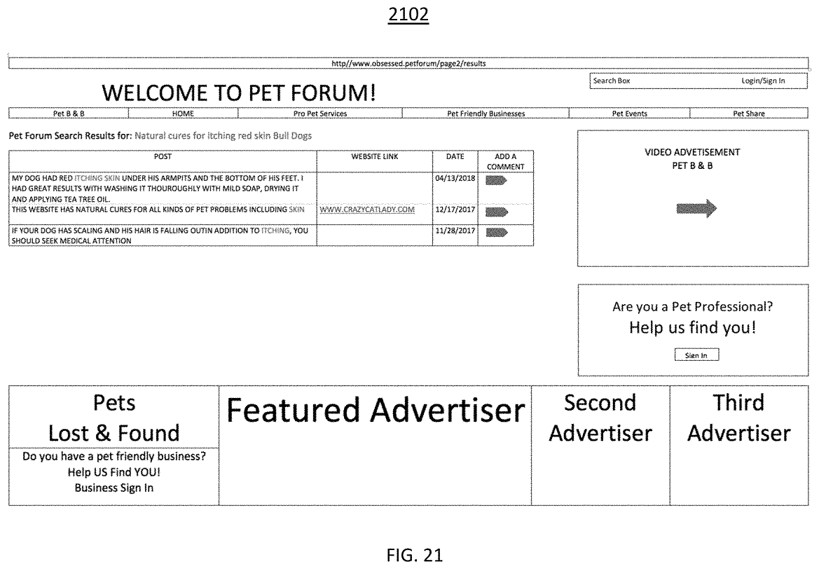

display results of a search in a pet forum (as described by FIG. 21 below); and

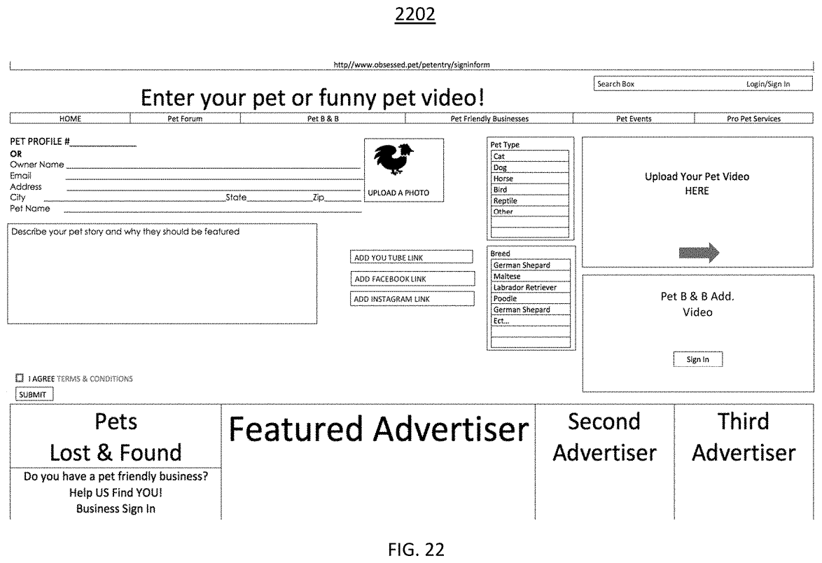

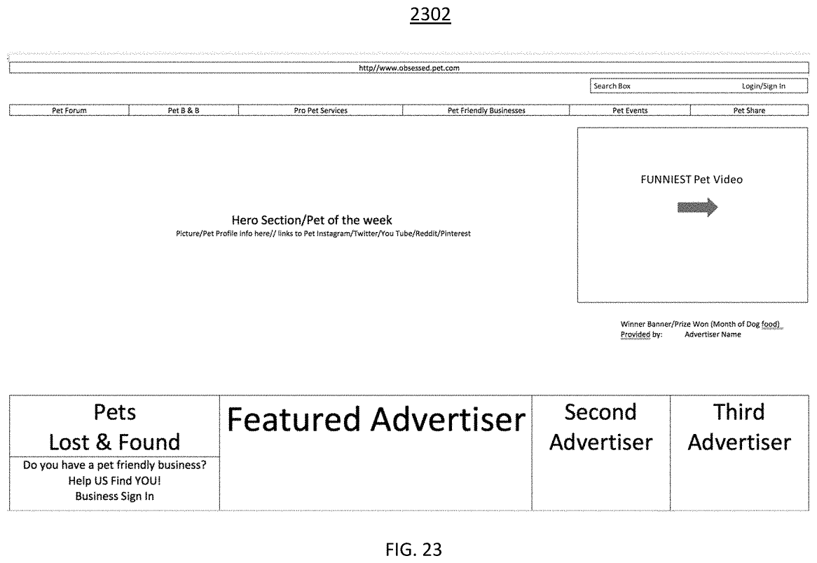

host a competition for fame or any form of prize (as described by FIGS. 22 and 23 below).

The software application 102 may make it possible for a pet owner to order and receive delivery of a meal for a pet. The pet owner may be able to select particular meals, or request a meal that corresponds to a special diet. The software application 102 may allow a pet owner to arrange a delivery time at a future scheduled date and time, or request immediate service.

The software application 102 may make it possible for a pet owner to arrange for their pet to be picked up by a driver that will safely deliver their pet to a pet host “nanny”, a pet day care business, a veterinarian, a groomer, or other pet professional. The software application 102 may allow a pet owner to arrange pickup and delivery times at a future scheduled date and time, or request immediate service.

The software application 102 may prompt and record background checks and check results for the driver, as well as for pet professionals. Results of background checks may be stored in a database, such as one of databases 216. A background check may be requested to a governmental or private entity by the software application 102 for the driver, a pet host, or for a pet professional. The software application 102 may include a user interface that enable an authorized user to request a background check or other form of verification, such as a business license status check for a business, a pet host, or a pet professional, or a license status check for a veterinarian or other pet professional subject to governmental licensing. The license status check may include a check to see if a license was ever issued, as well as the current status of the license. The software application 102 may use the results of background and other verification checks to assign a composite score to a pet professional, a pet host, a business, driver, or other individual or business discussed herein. The score, and/or results of the background and other verification checks may be used as a filter or screen so that only those pet professionals, businesses, hosts, drivers, or other individuals or businesses discussed herein that passed background and other verification checks are included in the pet community discussed herein. For example, only drivers with valid licenses, or only drivers without drunk driving arrests, or only veterinarians with valid professional licenses, only pet hosts without outstanding arrest warrants, or only businesses with sufficiently high BBB ratings, would be presented to pet owners. Other criteria may be set for verification testing.

In addition to background and other verification checks, the software application 102 may provide mechanisms for a pet owner to rate a pet professional, a business, a driver, or other individual or driver discussed herein. Such ratings may aggregated and be considered when generated composite scores. An average rating, or a composite score, may be displayed for a pet owner. The average rating or composite score may be used to sort potential pet professionals or businesses for selection by a pet owner. The average rating or composite score can also be thresholded, so that a pet professional, driver, business, or other individual or business discussed herein with too low an average rating and/or too low a composite score may be excluded from the community. A database 216 may record the individual and aggregate ratings and composite scores, as well as the background and other verification checks.

The software application 102 may provide mechanisms for a pet professional, a pet host, a driver, or an individual at a business to rate a pet owner. Such ratings may be used and aggregated so that a driver, a pet host, a pet professional, and a business may have additional information about a pet owner, and may use this information when determining whether to accept the pet owner as a client.

The rating systems may include a star rating, a traffic light rating, and/or an opportunity to include comments about the pet owner, pet host, pet professional, business or other individual or business discussed herein. The software application 102 may provide mechanisms for moderation of the rating systems to remove inappropriate comments.

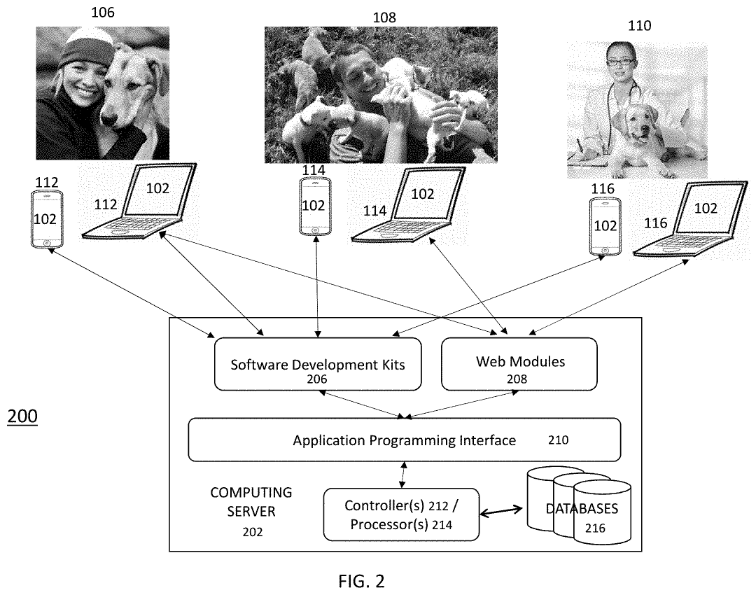

The computing server 104 can be a device or a computer program that can provide functionality for the computing devices 112, 114 and 116, which can be referred to as clients of the computing server 104. The computing server 104 can be a cloud computing server, as explained below by FIG. 2. In an alternate implementation, the computing server 104 can be a cluster of computers. In another implementation, the computing server 104 can be one or more of: a desktop computer, a laptop computer, a tablet computer, a phablet computer, a cellular/smart phone, and any other suitable computing device. The computing server 104 can be communicatively coupled with the computing devices 112, 114 and 116 via a communication network, such as one or more of: local area network, internet, wide area network, metropolitan area network, BLUETOOTH network, infrared network, wired network, and any other communication network.

The pet owners 106 can include managers or caretakers of pets who act on the direction of the pet owners 106. The pet hosts 108 can include entities that are willing to host pets owned by others either free or for a preset or pre-negotiated fee. The pet professionals or pet-related businesses 110 can include veterinarians, urgent care providers, wellness services, pet trainers, pet sitters, pet walkers, pet groomers, pet supply providers such as pet food retailers, and/or the like.

The computing device 112 can include one or more of: a desktop computer, a laptop computer, a tablet computer, a phablet computer, a cellular/smart phone, and any other suitable computing device. The computing device 114 can include one or more of: a desktop computer, a laptop computer, a tablet computer, a phablet computer, a cellular/smart phone, and any other suitable computing device. The computing device 116 can include one or more of: a desktop computer, a laptop computer, a tablet computer, a phablet computer, a cellular/smart phone, and any other suitable computing device. The computing devices 112, 114 and 116 may or may not be the same.

FIG. 2 illustrates a computing landscape 200 executing a software application 102 hosted by a computing server, where the computing server is a cloud computing server 202. The cloud computing server 202 can include one or more software development kits (SDKs) 206, one or more web modules 208, an application programming interface (API) 210, one or more controllers 212 including one or more processors 214, and one or more databases 216 connected to the one or more controllers 212.

The one or more SDKs 206 are configured to communicate, via a first communication network, with the computing devices 112, 114 and 116—where the computing device is a mobile device such as a phone, a tablet computer or a phablet computer—and the software application 102 executed thereon. The one or more web modules 208 can be configured to communicate, via a second communication network, with the computing devices 112, 114 and 116, wherein the computing device is a laptop or a desktop computer, and the software application 102 executed thereon. Each of the first communication network and the second communication network can be one or more of: local area network, internet, wide area network, metropolitan area network, BLUETOOTH network, infrared network, wired network, and any other communication network. In one implementation, the first communication network and the second communication network may be the same network. In another implementation, the first communication network and the second communication network may be different networks.

The API 210 can be a set of subroutine definitions, protocols, and/or tools that define method of communication between the software application 102 and the cloud computing server 202. The API 210 can ensure, for example, that the data from the at least one of the one or more SDKs 206, and the one or more web modules 208 can be read by the one or more controllers 212 and the one or more processors 214.

Each database 216 can be a cloud database, which can advantageously permit an easy scalability of the database 216 when required (e.g., when additional data needs to be stored, which can happen, for example, when the number of pets, pet owners, pet hosts, pet professionals, and pet-related businesses registered with the software application 102 increase beyond a threshold value. In one implementation, access to that database 216 can be provided as a service. In some implementations, the database 216 can be run on virtual machine instances. In one implementation, the database 216 can be a disk storage. In some alternate implementations, the database 216 can be a main memory (e.g., random access memory) rather than a disk storage. In those alternate implementations, access of data from the main memory can advantageously eliminate seek time when querying the data, which can provide a faster access of data, as compared to accessing data from the disk.

The use of a cloud computing server 202 can be advantageous over a traditional server, as the cloud computing server 202 permits a quick scalability by addition of additional web services within in a few seconds. When the load on the software application 102 increases, additional processors 214 or databases 216 can be added—or alternately the processing abilities of the existing processors 214 or databases 216 can be enhanced—within a few seconds. Additionally, inclusion of all of the one or more SDKs 206, one or more web modules 208, API 210, at least one data processor 214, and database 216 within the cloud computing server 202 can advantageously enable: a dynamic provisioning, monitoring and managing of the software application 102; as well as a quick (e.g., within a few seconds) and easy restoring the software application 102 to a previous version of that application if and when required.

FIG. 3 illustrates a page 302, executed by the software application 102, for a pet owner 106 to register a pet. To register, the pet owner 106 can create a pet profile for the pet, which can include identifying data of the owner, identifying data of the pet, type of pet, breed of the pet, size of the pet, marketing information of the pet, a description of when the pet is available for sharing, needs of the pet, whether the sharing is free or entails a fee, and/or the like. The identifying data of the owner can include name, email, address, and/or the like.

FIG. 4 illustrates a page 402, executed by the software application 102, where a pet host can provide identifying information, address, services provided, pets to which the services are limited, and/or the like.

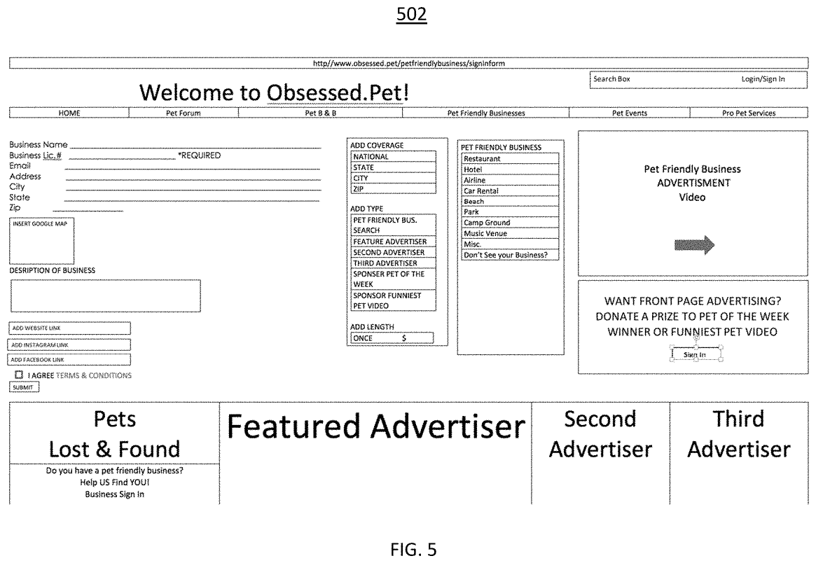

FIG. 5 illustrates a page 502, executed by the software application 102, for a pet friendly business 110 to register the pet friendly business 110.

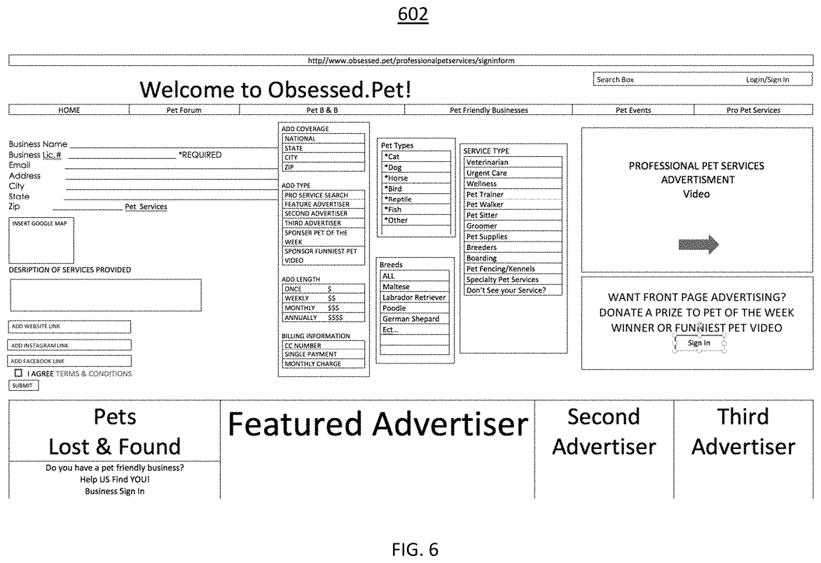

FIG. 6 illustrates an alternate page 602 (i.e., alternate to page 502 of FIG. 5), executed by the software application 102, for a pet professional/business 110 to register the pet professional/business 110.

FIG. 7 illustrates a page 702, executed by the software application 102, for an individual to search for available pets to share ownership based on geographic area, pet type, and/or breed.

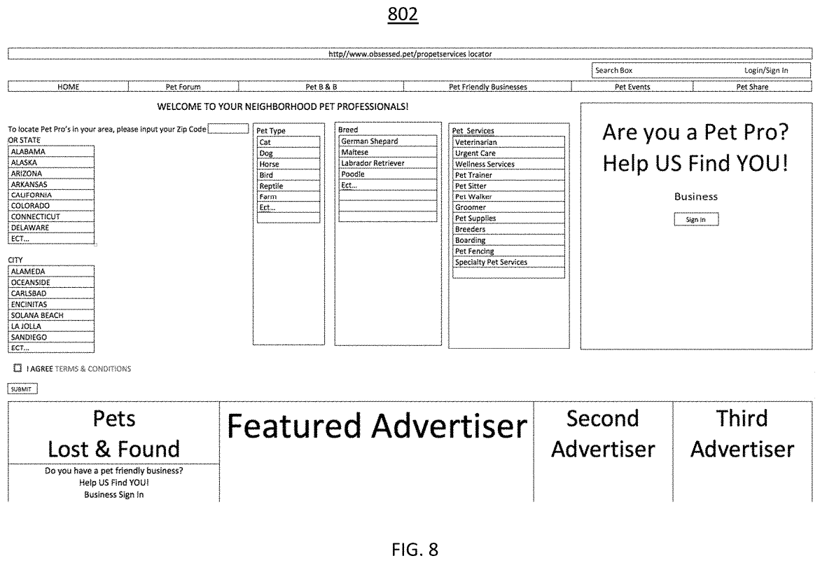

FIG. 8 illustrates a page 802, executed by the software application 102, for a pet owner 106 to search for pet professionals/businesses based on geographic area, pet type, pet breed, and/or services offered.

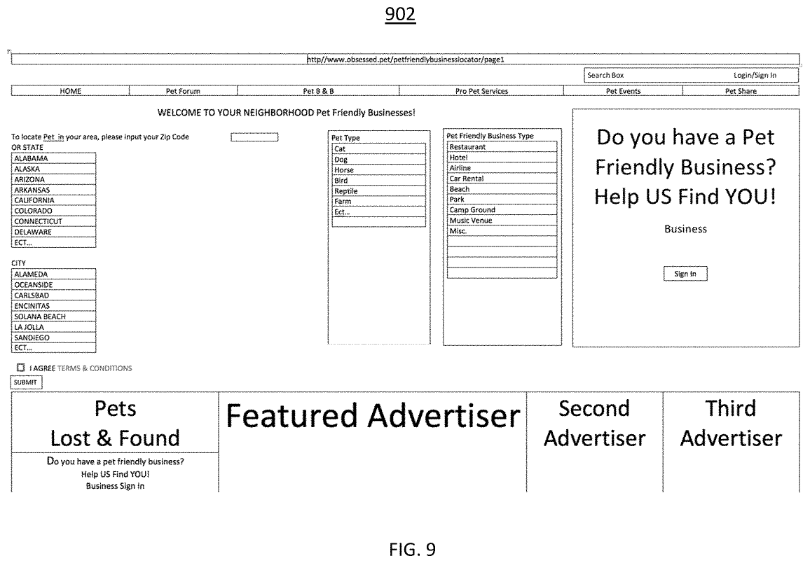

FIG. 9 illustrates an alternate page 902 (i.e., alternate to page 802 of FIG. 8), executed by the software application 102, for a pet owner 106 to search for pet friendly-businesses based on geographic area, pet type, and type of the pet friendly business.

FIG. 10 illustrates a page 1002, executed by the software application 102, showing results of a search for pet friendly businesses based on geographic area.

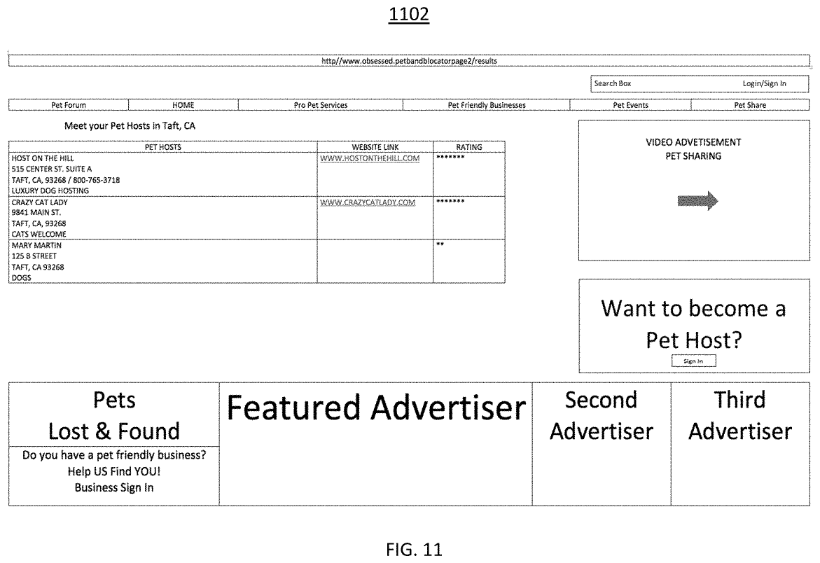

FIG. 11 illustrates another page 1102, executed by the software application 102, showing results of a search for pet hosts based on geographic area.

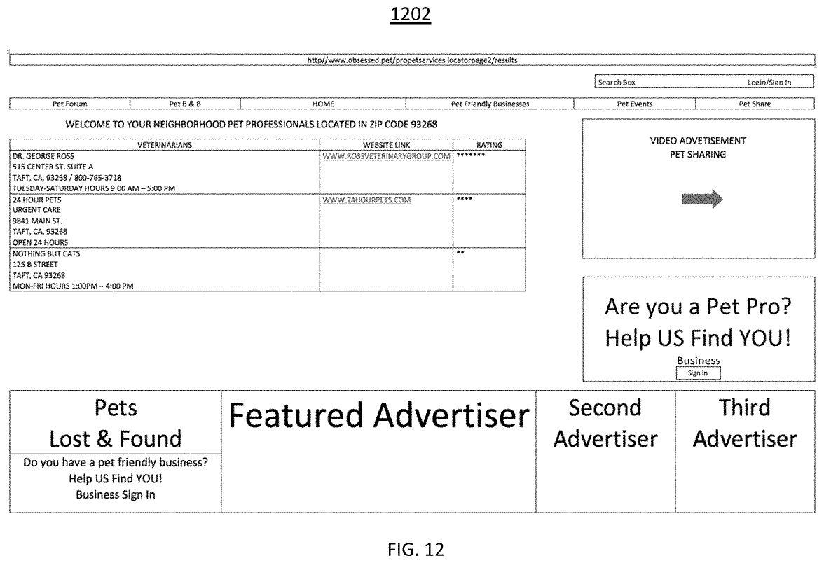

FIG. 12 illustrates yet another page 1202, executed by the software application 102, showing results of a search for pet professionals/businesses based on geographic area.

FIG. 13 illustrates a page 1302, executed by the software application 102, for a pet owner 106 to specify dates on a calendar when his/her pet is in need of a pet host providing board and care services based on a geographical area.

FIG. 14 illustrates a page 1402, executed by the software application 102, showing results of a search, usually by an individual, for pets that are available for sharing in a specified geographic area.

FIG. 15 illustrates a page 1502 executed by the software application 102 for an organizer of an event related to pets to create pet events on a calendar that can be accessed by pet owners, pet hosts, and pet professionals/businesses. The calendar may permit or require the event organizer to specify or identify the geographic location of the event so that the events are searchable according to geographic location.

FIG. 16 illustrates a page 1602, executed by the software application 102, where an individual can search for events related to pets, based on a calendar and geographical area.

FIG. 17 illustrates a page 1702, executed by the software application 102, showing results of a search of events in a specified geographic area.

FIG. 18 illustrates a page 1802, executed by the software application 102, where an individual can post a lost or found pet including a date found or lost and geographical area, which includes timed information for lost and found objects associated with pets.

FIG. 19 illustrates a page 1902, executed by the software application 102, showing search results with categories of most recently lost or found pets.

FIG. 20 illustrates a page 2002, executed by the software application 102, having a pet forum, which is searchable. The pet forum allows pet owners 106 to post questions and receive answers from other pet owners 106. The pet forum can additionally show recently asked questions and corresponding responses, as well as most popular threshold number of questions and responses thereto.

FIG. 21 illustrates a page 2102, executed by the software application 102, showing results of a search in the pet forum.

FIG. 22 illustrates a page 2202, executed by the software application 102, where a pet owner can post a photo or video of their pet to win fame, competition, or prize.

FIG. 23 illustrates a page 2302, executed by the software application 102, that compares the entries made using the page 2202 and posts the winner of the competition for fame or a prize thereon.

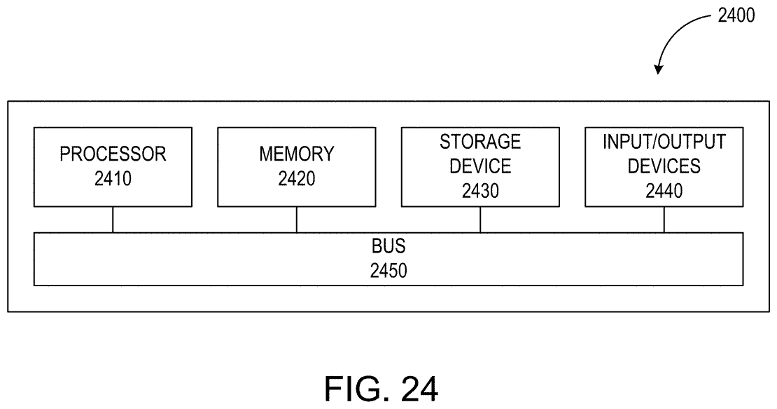

FIG. 24 depicts a block diagram illustrating a computing system 2400 consistent with implementations of the current subject matter. Referring to FIGS. 1 and 2, the computing system 500 can be used to implement the software application 102 on a computing server 104 or 202, or a computing device 112, 114, or 116, the database 216, and/or any components therein.

As shown in FIG. 24, the computing system 2400 can include a processor 24310, a memory 2420, a storage device 2430, and input/output devices 2440. The processor 2410, the memory 2420, the storage device 2430, and the input/output devices 2440 can be interconnected via a system bus 2450. The processor 2410 is capable of processing instructions for execution within the computing system 2400. Such executed instructions can implement one or more components of, for example, the client 2410. In some implementations of the current subject matter, the processor 2410 can be a single-threaded processor. Alternately, the processor 2410 can be a multi-threaded processor. The processor 510 is capable of processing instructions stored in the memory 2420 and/or on the storage device 2430 to display graphical information for a user interface provided via the input/output device 2440.

The memory 2420 is a computer readable medium such as volatile or non-volatile that stores information within the computing system 2400. The memory 2420 can store data structures representing configuration object databases, for example. The storage device 2430 is capable of providing persistent storage for the computing system 2400. The storage device 430 can be a floppy disk device, a hard disk device, an optical disk device, or a tape device, or other suitable persistent storage means. The input/output device 440 provides input/output operations for the computing system 2400. In some implementations of the current subject matter, the input/output device 2440 includes a keyboard and/or pointing device. In various implementations, the input/output device 2440 includes a display unit for displaying graphical user interfaces.

According to some implementations of the current subject matter, the input/output device 2440 can provide input/output operations for a network device. For example, the input/output device 2440 can include Ethernet ports or other networking ports to communicate with one or more wired and/or wireless networks (e.g., a local area network (LAN), a wide area network (WAN), the Internet).

In some implementations of the current subject matter, the computing system 2400 can be used to execute various interactive computer software applications that can be used for organization, analysis and/or storage of data in various (e.g., tabular) format (e.g., Microsoft Excel®, and/or any other type of software). Alternatively, the computing system 2400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 2440. The user interface can be generated and presented to a user by the computing system 2400 (e.g., on a computer screen monitor, etc.).

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more computing servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system, comprising:
at least one data processor; and
at least one memory storing instructions which, when executed by the at least one data processor, result in operations comprising:
receiving a request to access a pet service from a first computing device;
retrieving, from a database, at least one pet service providers providing the pet service, the at least one pet service provider associated with a composite score, the composite score generated based on at least one of a verification check, a background check, and a rating;
selecting at least one of the at least one pet service providers based on the composite score of the at least one of the at least one pet service providers; and
in response to the request, routing the at least one pet service providers selected based on the composite score to the first computing device.

2. The system of claim 1, the operations further comprising:
receiving a user selection of one of the at least one pet service providers from the first computing device; and
in response to receiving the user selection, routing an identifier of the first computing device to a second computing device, the first computing device associated with a pet owner, the second computing device associated with a pet service provider.

3. The system of claim 1, wherein the pet service provider comprises a pet host.

4. The system of claim 1, wherein the pet service provider comprises a pet professional.

5. The system of claim 4, wherein the pet professional comprises a veterinarian.

6. The system of claim 1, wherein the pet service comprises a pet-related business.

7. A computing server comprising:
at least one of a first software development kit and a first web module to communicate with a first computing device, a second computing device of a pet host, and a first computing device of a pet professional;
an application programming interface communicatively coupled with the at least one of the first software development kit and the first web module; and
a first controller communicatively coupled to the application programming interface, the first controller comprising a first configured to selectively display different aspects of a software application on the first computing device, the second computing device, and the third computing device.

8. The computing server of claim 8, wherein:
the first computing device is configured to be operated by a pet owner;
the second computing device is configured to be operated by a pet host; and
the third computing device is configured to be operated by a pet professional.

9. The computing server of claim 8, further comprising a database communicatively coupled to the first processor.
